(19) United States
(12) Patent Application Publication
(10) Pub. No.: US 2025/0238651 A1
(43) Pub. Date: Jul. 24, 2025

(54) EMOTION RECOGNITION SYSTEM WITH HYPERDIMENSIONAL COMPUTING ACCELERATOR

(71) Applicant: Intelligent Information Security Technology Inc., Hsinchu (TW)

(72) Inventors: Wai-Chi Fang, Hsinchu (TW); Jia-Yu Li, Hsinchu (TW)

(21) Appl. No.: 18/905,126

(22) Filed: Oct. 2, 2024

Related U.S. Application Data
(60) Provisional application No. 63/623,800, filed on Jan. 22, 2024.

(51) Int. Cl. G06N 3/004

(52) U.S. Cl. CPC G06N 3/004

(57) ABSTRACT

The invention relates to an emotion recognition system based on a hyperdimensional computing (HDC) accelerator, which performs emotion recognition by analyzing electroencephalogram (EEG) spectrograms and utilizing machine learning. The emotion recognition system introduces hyperdimensional computing accelerator for affective computing based on 16-channel EEG spectrograms. The system features two continuous item memories and spatial-temporal encoders to improve recognition accuracy. In feature extraction, short-time Fourier Transform (STFT), baseline normalization, and quantization are employed. The advantages of the algorithm include hardware-friendly and highly parallel efficient computation, rapid convergence with single-pass training, and the capability for few-shot learning. Additionally, a dedicated accelerator for HDC is designed, enabling high-speed and energy-efficient results while maintaining comparable accuracy.

### CROSS REFERENCE TO RELATED APPLICATIONS

The present application claims the benefit of U.S. Patent Application No. 63/623,800 filed on Jan. 22, 2024, the contents of which are incorporated herein by reference in their entirety.

### TECHNICAL FIELD

The present invention relates to an integrated accelerator-based emotion recognition system, particularly to an emotion recognition system with a hyperdimensional computing accelerator.

### BACKGROUND

The rapid transformation in AI-driven healthcare, particularly in EEG-based emotion recognition, holds significant promise for clinical psychology, human-computer interaction, and personalized healthcare. AI's ability to process vast datasets and derive meaningful insights complements the interconnected nature of IoT devices, creating a seamless and intelligent healthcare ecosystem. In our interconnected world, the surge in demand for intelligent systems capable of perceiving and responding to human emotions has been exponential. This transformation, prominently seen in EEG- based emotion recognition, is poised to revolutionize clinical psychology, human- computer interaction, and personalized healthcare. Wearable devices, particularly those with Brain-Computer Interface (BCI) capabilities, offer a solution by enabling continuous remote monitoring of individuals' emotional well-being. The true potential of this technology lies in its ability to provide real-time, continuous monitoring, allowing for proactive interventions and personalized care.

The synergy between artificial intelligent (AI) and IoT has been a driving force in enhancing healthcare devices. By leveraging edge computing and streamlined hardware design, these advancements have significantly improved the efficiency, reduced latency, increased mobility of healthcare applications, and minimized power consumption. However, as we attempt to enable mobile remote emotion recognition with AI, a unique set of challenges emerges. The need for instantaneous detection of dynamic emotional states necessitates the development of accurate, efficient edge AI algorithm and design.

Traditional AI neural networks, while proficient in delivering highly accurate results, encounter obstacles when venturing into the realm of edge computing for IoT. Efficient processing of Deep Neural Networks (DNN) necessitates consideration of factors such as accuracy, robustness, power and energy consumption, high throughput, low latency, and hardware cost.

In conclusion, to overcome the shortcomings, the inventors of the present application have devoted significant research and development efforts and spirit, continuously breaking through and innovating in the present field. It is hoped that novel technological means can be used to address the deficiencies in practice, not only bringing about better products to society but also promoting industrial development.

### SUMMARY

The main objective of the present invention is to provide an emotion recognition system based on a hyperdimensional computing (HDC) accelerator. The HDC accelerator introduced by the present invention incorporates a novel algorithm that leverages high-dimensional computing to improve efficiency. The HDC accelerator is used for affective computing based on 16-channel EEG spectrograms. Compared to traditional neural networks, HDC excels in efficiency, computational complexity, and speed, while maintaining comparable accuracy in emotion recognition. The system features two continuous item memories and spatiotemporal encoders, significantly enhancing recognition accuracy. In feature extraction, short-time Fourier transform (STFT), baseline normalization, and quantization are employed, with leave-one-subject-out validation conducted on the public SEED dataset and the private KMU dataset. Through updated prototype method, the HDC model achieved an accuracy of 87.74% on the public SEED dataset and 79.23% valence and 85.98% arousal on the private KMU data.

To achieve the above-mentioned objective, the present invention provides an emotion recognition system with a hyperdimensional computing accelerator, comprising a database, a processor and an electronic device. The database includes at least one original physiological signal. The processor is communicatively connected to the database, and the processor retrieves the at least one original physiological signal from the database and performs calculations. Furthermore, the processor includes: a feature extraction module and a hyperdimensional computing accelerator; wherein the feature extraction module processes the extracted original physiological signal to obtain a plurality of quantitative features. Additionally, the hyperdimensional computing accelerator is designed with a hardware circuit and is communicatively connected to the processor through an interface. The quantitative features are computed in the hyperdimensional computing accelerator to complete an initial training module and an emotion classification result. Furthermore, the electronic device is communicatively connected to the processor through the interface, and is used to display the initial training module and the emotional classification result.

Moreover, the hyperdimensional computing accelerator includes: a top-level module, a mapping module, a spatial module, a temporal module, and an associative memory module; wherein the top-level module manages all modules within the hyperdimensional computing accelerator and executes a finite state machine to process hyperdimensional computing in a pipeline fashion, selectively implement clock gating, which significantly reduces power consumption. In the mapping module, the quantized features, frequency information, and channel information are encoded using hardwiring and cellular automata. The mapping module translates the quantized features into a binary hypervector of 10,000 dimensions and maps frequency and channel information into corresponding hypervectors. The spatial module employs XNOR gates and a 9-bit accumulator for hypervector to implement binding and bundling operations to form a plurality of bound vectors, and are then bundling together to form a SE hypervector. The temporal module utilizes a straightforward shift operation and a plurality of registers that store n-gram hypervectors to left-shift the SE hypervector by one bit, capturing sequential n-grams and amalgamate them into a TE hypervector. The associative memory module includes an inference mode and a training mode. In the inference mode, a similarity check is applied to identify the closest relation between the temporal encoder (TE) hypervector and prototype, thereby recognizing the corresponding classification. In the training mode, a majority vote is implemented to bundling the TE hypervector with the prototype where the label is located within a window segment. The prototype is then binarized into a binary hypervector to perform real-time emotion recognition, generating the emotion classification result and the initial training model.

### BRIEF DESCRIPTION OF THE DRAWINGS

FIG. 1 is a schematic diagram of an emotion recognition system with a hyperdimensional computing accelerator according to the present invention.

FIG. 2 is a data processing flowchart of the emotion recognition system according to the present invention.

FIG. 3 is a schematic diagram of the hyperdimensional computing model according to the present invention.

FIG. 4 is a system architecture diagram of the present invention.

FIG. 5 is a flowchart of the hyperdimensional computing accelerator according to the present invention.

FIG. 6 is a block diagram of the hyperdimensional computing accelerator according to the present invention.

FIG. 7 shows the two-class emotion classification results for 15 subjects on the SEED dataset according to the present invention.

FIG. 8 shows the two-class confusion matrix diagrams for subjects 1 to 8 according to the present invention.

FIG. 9 shows the two-class confusion matrix diagrams for subjects 9 to 15 according to the present invention.

FIG. 10 shows arousal of two-class classification results on the KMU dataset according to the present invention.

FIG. 11 shows valence of two-class emotion classification results on the KMU dataset according to the present invention.

FIG. 12 shows a circumplex model of valence for 40 subjects on the KMU dataset according to the present invention.

### DETAILED DESCRIPTION

In order to enable a person skilled in the art to better understand the objectives, technical features, and advantages of the invention and to implement it, the invention is further elucidated by accompanying appended drawings. This specifically clarifies the technical features and embodiments of the invention, and enumerates exemplary scenarios. To convey the meaning related to the features of the invention, the corresponding drawings herein below are not and do not need to be completely drawn according to the actual situation.

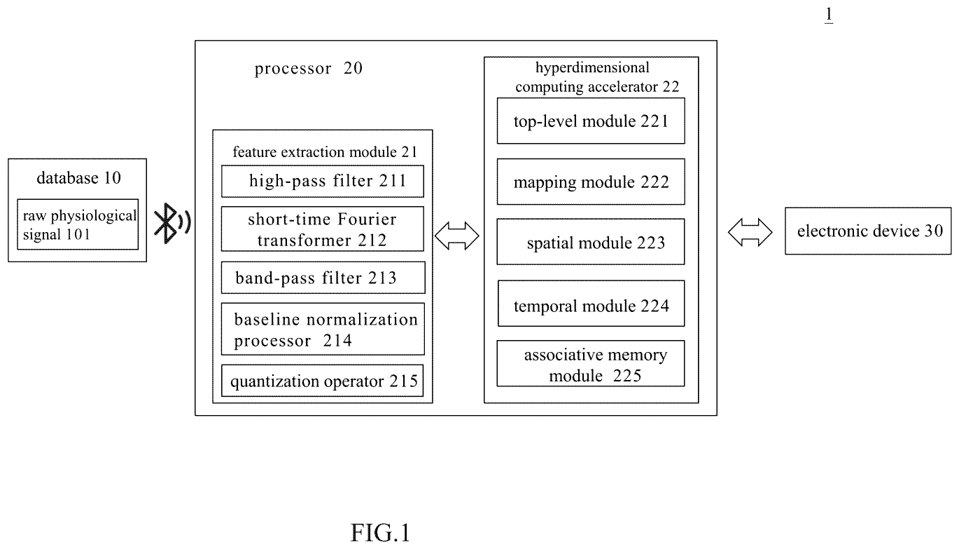

As shown in FIG. 1, an objective of the present invention is to provide an emotion recognition system 1 with a hyperdimensional computing accelerator, which includes a database 10, a processor 20, and an electronic device 30. The database 10 contains at least one set of raw physiological signals 101 and includes the public SEED dataset and a non-public KMU dataset. These physiological signal data are obtained through a front-end sensor 10a, which is a wearable EEG headset equipped with 16 electrodes 111, a dedicated front-end circuit 112, a microcontroller 113, and a Bluetooth module 114.

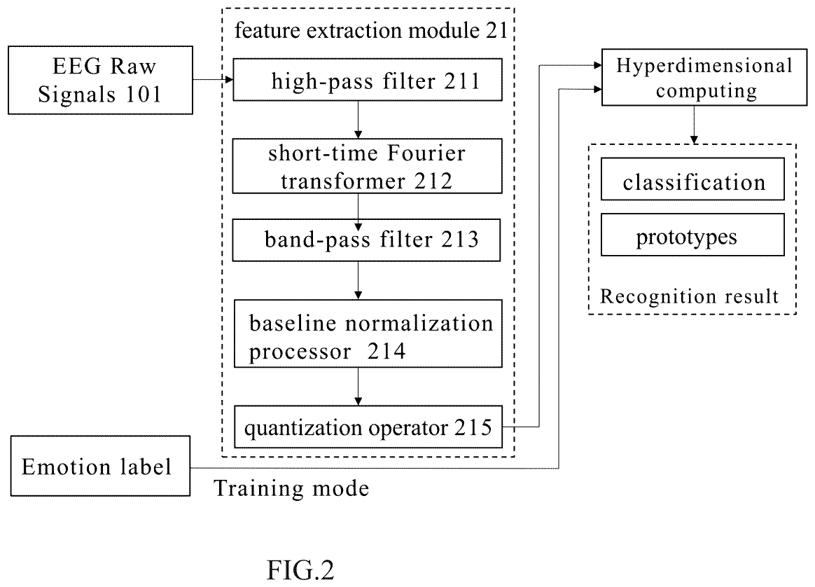

As shown in FIGS. 1 to 3, the processor 20 is communicatively connected to the database 10. The processor 20 is based on a fifth-generation Reduced Instruction Set Computer (RISC) architecture and includes at least a feature extraction module 61 and a hyperdimensional computing accelerator 22. The feature extraction module 21 processes the at least one raw physiological signal to obtain multiple quantized features. The feature extraction module 21 includes a high-pass filter 211, a short-time Fourier transformer 212, a band-pass filter 213, a baseline normalization operator 214, and a quantization operator 215. The high-pass filter 211 eliminates baseline drift from the at least one raw physiological signal and minimizes noise to address potential disruptions caused by baseline drift. The short-time Fourier transformer 212 converts the at least one physiological signal into a frequency domain spectrogram. The band-pass filter 213 extracts the features from the alpha, beta, and gamma frequency bands. The baseline normalization operator 214 scales each data point based on a mean value, and the quantization operator 215 converts the features extracted by the band-pass filter 213 into levels suitable for high-dimensional vector mapping. To integrate with hyperdimensional computing, the processed spectrogram undergoes quantization, converting it into levels suitable for high-dimensional vector mapping in the final step. According to statistics, approximately 99.7% of the values are highly concentrated near zero. For pattern analysis within the features, a range of −1 to 9 is selected, applying floor-mode quantization to divide the features into 200 levels.

Secondly, the hyperdimensional computing accelerator 22 is designed with hardware circuitry and is connected to the quantization operator 215 via an interface 201. It processes the quantized features within the hyperdimensional computing accelerator 22 to complete an initial training module and generate an emotion classification result. Additionally, the hyperdimensional computing accelerator 22 includes a top-level module 221, a mapping module 222, a spatial module 223, a temporal module 224, and an associative memory module 225. The top-level module 221 executes a finite state machine in a pipelined manner to handle hyperdimensional computing and manages all the modules within the hyperdimensional computing accelerator 22, selectively performing clock gating control to reduce power consumption.

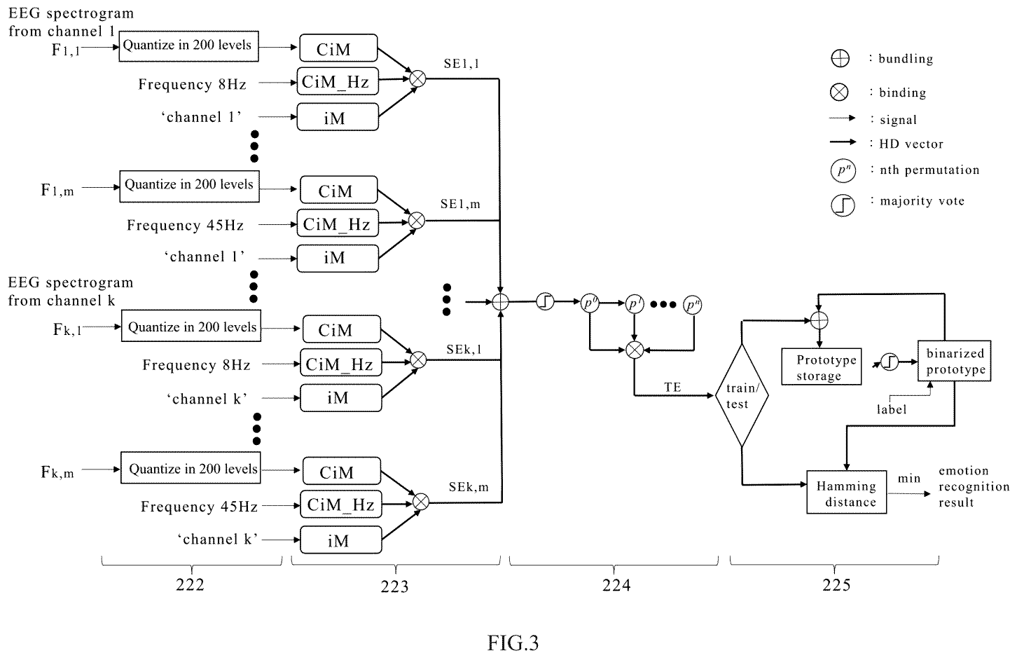

As shown in FIG. 3, the mapping module 222 encodes the quantized features, frequency information, and channel information using a hard wiring and a cellular automata, converting these quantized features into a binary hypervector of 10,000 dimensions and mapping the frequency information and channel information to corresponding hypervectors. The mapping module 222 includes an Item Memory (iM) mechanism and a continuous Item Memory mechanism. The Item Memory serves as a storage repository for discrete information and has the capability to store and retrieve specific items. The Item Memory mechanism employs Rule 90 cellular automata (CA) to label a channel name, allowing the hypervector to be used for sequence extraction to generate a pseudorandom vector. Specifically, CA Rule 90 is a one-dimensional, binary cellular automaton rule that evolves over discrete time steps. In this rule, each cell in a generation updates its state based on the states of itself and its two neighbors in the previous generation, with a simple XOR operation. Specifically, if the two neighbors are different, the cell in the next row becomes 1; otherwise, it becomes 0.

Next, compared to the iM, the continuous Item Memory (CiM) extends the memory capability of Hyperdimensional Computing (HDC) to seamlessly handle continuous data streams. In the continuous Item Memory (CiM) mechanism, the target range is first quantized into q levels, necessitating the generation of q continuous hypervectors. A d-dimensional pseudorandom vector acts as the first random seed. By intentionally flipping half of the bits (d/2) of the first random seed to generate the maximum level, the intentional flipping ensures that the hypervector representing the maximum level is dissimilar to the random seed representing the minimum level, as the Hamming distance is manually set to 0.5. The flipped bits are randomly segmented into q-1 groups, and then the first random seed is flipped group by group to generate neighbor levels from the minimum level to the maximum level.

Additionally, the spatial module 223 employs a logic gate and a 9-bit accumulator to bind and bundling the hypervectors related to channel information, frequency information, and feature information to form multiple binding vectors. These binding vectors are then bundling together to create a Spatial Encoding (SE) hypervector. Binding merges two hypervectors into one, integrating diverse information, while bundling summarizes channel-specific details into a unified hypervector. Furthermore, the temporal module 224 uses a straightforward shift operation and multiple registers to store n-gram hypervectors to left-shift the hypervector by one bit, extract consecutive n-grams, and amalgamate the consecutive n-grams into a temporal encoding hypervector.

As shown in FIG. 3, the present invention uses two distinct continuous item memories, one dedicated to spectrogram values (CiM) and the other to frequencies (CiM Hz), reflecting the 2D nature of EEG spectrogram. In the spectrogram, the frequency domain displays continuous strength and correlation with neighboring levels, thus improving accuracy when utilizing CiM for mapping frequency information. In hyperdimensional computing hardware design, the focus is on binary dense codes, where the elements of hypervectors equally and probabilistically consist of 1s and 0s. Hyperdimensional computing involves manipulating high-dimensional binary vectors through operations such as multiplication (binding), addition (bundling), and permutation. Binding (denoted as A⊗B) entails the element-wise multiplication of two high-dimensional binary vectors to generate a novel vector that encapsulates the joint information of its original counterparts, resulting in a hypervector that is dissimilar (orthogonal) to the constituent hypervectors. Furthermore, bundling (denoted as A⊕B) in hyperdimensional computing involves element-wise addition of high-dimensional binary vectors. This operation combines information from different sources to create a new hypervector. After bundling in hyperdimensional computing, a majority voting operation is typically applied to generate a hypervector consistent with the type of seed vector used.

In FIG. 3, the bundling operation (addition) is used twice, followed by majority voting. In the spatial module, the bundling operation functions to aggregate channel information, including the spectrogram, channel names, and frequency. After bundling, the resulting vector is binarized with a threshold set at half of its summation i.e., threshold=(number of channels)×frequency/2. With 16 channels and a frequency range of 38 (8-45 Hz), this results in a threshold of 304. In the associative memory module, the bundling operation is used to converge the TE hypervector generated by the temporal module. The mathematical nature of the bundling operation implies that the more bases involved in superposition, the more general the prototype becomes. However, considering hardware constraints, an increase in the number of bases summed leads to larger memory usage, particularly in d-dimensional space, where the storage can become exceptionally large. To balance accuracy and memory usage, a 30-second window updated every 5 times is chosen to effectively manage the design area while maintaining accuracy.

In hyperdimensional computing, the permutation operation, denoted as ρ(A), can be applied recursively, projecting into previously unoccupied spaces with each iteration. This operation is crucial for storing sequences as it ensures distinguishability between different orders, such as a-b-c versus b-c-a. This operation effectively combines a hypervector with the position in a sequence, representing symbol at specific locations. Permutation creates dissimilar, pseudo-orthogonal hypervectors that maintain distances and are seamlessly distributed over bundling and binding operations. In the context of emotion recognition using physiological signals, the importance of temporal emotional information is emphasized, especially when dealing with sequential EEG data. Therefore, permutation is used to encode data, effectively preserving sequence information and the original data content. The permutation operation is applied to each hypervector, with the number of permutations gradually decreasing with each time step.

The associative memory module 225 includes an inference mode and a training mode. In the inference mode, a similarity check is applied to identify the closest relation between the temporal encoding hypervector and prototype to determine the corresponding classification. In the training mode, a majority voting method is used to bundling the temporal encoding hypervector with the prototype where the label is in a window segment. Subsequently, the prototype is binarized back into a binary hypervector, and perform real-time emotion recognition to produce the emotion classification result and the initial training module. The associative memory module 225 stores integer prototype and binary prototype for both modes. In training mode, the binary prototype are updated every 5 passes by thresholding the integer window prototype within a 30-sample window. In inference mode, prototype stored in an associative memory register are extracted for comparison with the temporal encoding hypervector, the output of the temporal module. The Hamming distance computation involves XOR gates, addition trees, and comparators. Finally, the classification result is determined based on the similarity calculated by the Hamming distance. In the final stage, high-dimensional computing is used to extract key features from the quantization, enabling the inference mode for emotion classification, while the emotional patterns are stored as prototype in the training mode, accompanied by input emotion labels. Finally, the electronic device 30 communicates with the processor 20 through the interface 201, with the electronic device 30 used to display the initial training module and the emotion classification result.

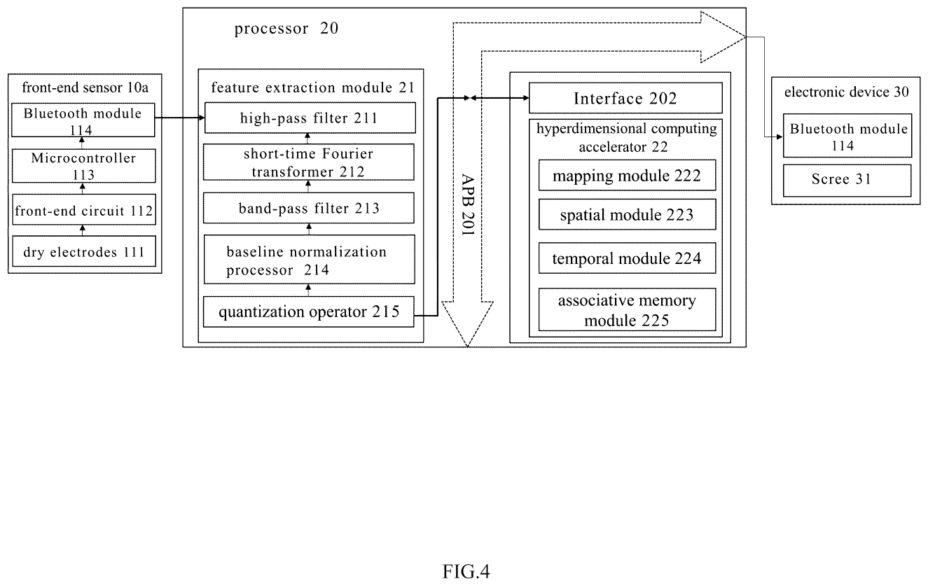

As shown in FIG. 4, the hyperdimensional computing accelerator 22 includes mapping, time encoding, spatial encoding, and associative memory functions. The hyperdimensional computing accelerator 22 implemented on the Kintex 7 FPGA serves as a customized peripheral module, seamlessly integrated with the RISC-V architecture via the Advanced Peripheral Bus (APB) 202. Similarly, the RISC-V CPU communicates with the HDC accelerator through control registers via the APB 202. In the HDC registers, most parameters are restricted from modification, allowing the user to select the number of channels and processing mode for the EEG spectrogram.

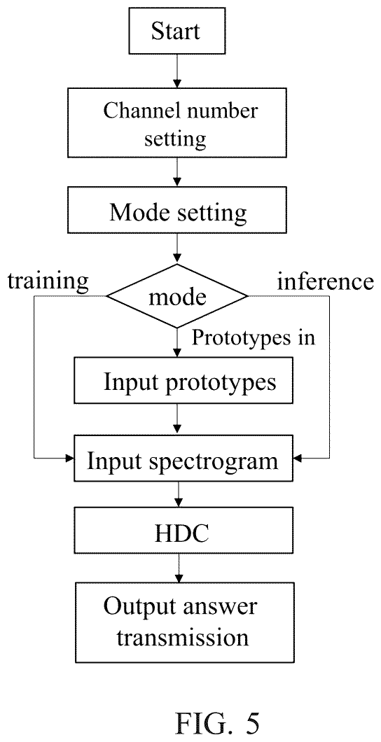

As shown in FIG. 5, first, the channel number and the processing mode are configured, covering both inference and training modes. In ‘prototype in’ mode, pretrained prototype are loaded from a pre-trained model. In the inference mode, the processor 20 initializes prototype unless already stored in the associative memory, enabling direct processing if available. The input spectrogram then undergoes hyperdimensional computing, yielding an output.

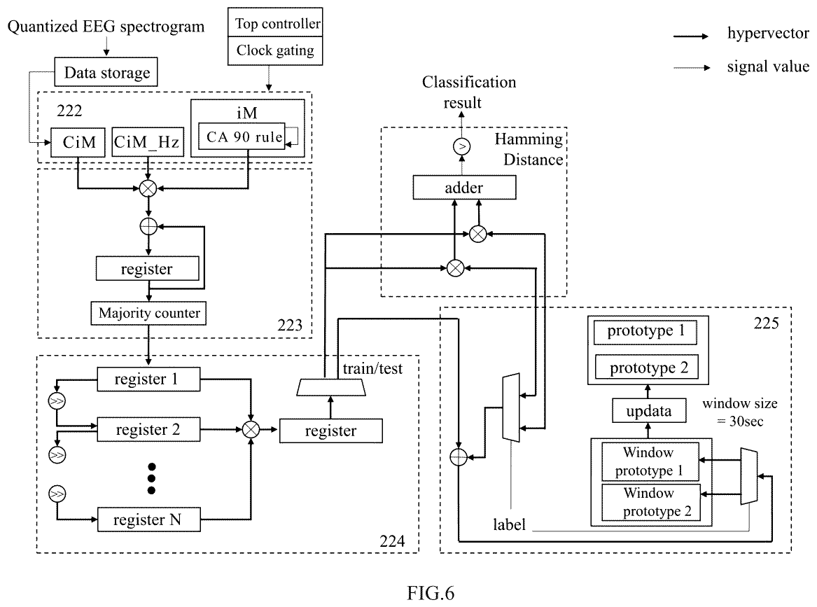

As shown in FIG. 6, the bold lines denoting hypervectors, and the thin lines represent signals. The interaction from the processor 20 to the accelerator 22 involves the interface 201, which translates Advanced Peripheral Bus (APB) 202 instructions into setting parameters and stores the EEG spectrograms in a dedicated buffer. The top controller acts as the top-level module 221, managing all modules within the accelerator and executing a finite state machine to process hyperdimensional computing in a pipeline fashion. Additionally, the hardware design by reducing the hyperdimension d from 10,000 to 2000, achieving an 80% area savings. In the mapping module 222, quantized EEG spectrogram, frequency, and channel information are encoded using hard wiring and cellular automata to minimize memory storage usage. The spatial module 223 employs XNOR gates and a 9-bit accumulator for hypervector to implement binding and bundling operations. Following accumulation, a majority counter and thresholding are applied to each element in parallel using comparators. The temporal module 224 utilizes a straightforward shift operation and 7 registers to store n-gram hypervectors, which are then bound together to form the TE hypervector. In the associative memory module 225, it stores both integer prototype and binary prototype for two-class patterns. Binary prototype undergo updates in a 30-sample window every 5 times through thresholding of integer window prototype in training mode. During inference mode, prototype stored in associative memory registers are extracted for comparison with the TE hypervector, the output of the temporal encoder.

### SEED Database

To ensure a comprehensive validation and comparison, the inventors chose the publicly available EEG dataset, SEED, published by Shanghai Jiao Tong University. The experiment involved 15 participants, comprising 8 females and 7 males. Each subject underwent three emotion induction experiments to gather sufficient analysis data. The emotion induction experiments utilized 15 Chinese film clips to stimulate positive, negative, and neutral emotional states. Each experiment consisted of a 5-second hint, a 4-minute stimuli clip, 45 seconds for self-assessment, and a 15-second rest period after each emotion induction to prevent emotional disturbance between inductions.

### KMU Dataset

In addition to public open datasets, the inventor conducted validation on a private EEG dataset collected by the psychology department team at Kaohsiung Medical University (KMU) from 52 patients diagnosed with high cardiovascular-related risk. The emotion induction experiment consisted of two stages: a training stage and an experiment stage. During the training stage, participants were tasked with learning and becoming used to emotion recall. The goal was to enable participants to quickly recall memories that could induce four emotion states (neutral, angry, happy, sadness). In the experiment stage, physiological signals including EEG, ECG, PPG, and blood pressure were recorded. Before inducing emotion, a 5-minute baseline data recording was performed, and participants were asked for self-assessment. The experiment recorded each emotion state for 11 minutes, comprising a 3-minute statement period, a 3-minute recall period, and a 5-minute recovery period. All physiological signals were downsampled to 256 Hz for synchronization. As in the SEED dataset, the same channels are selected for analysis.

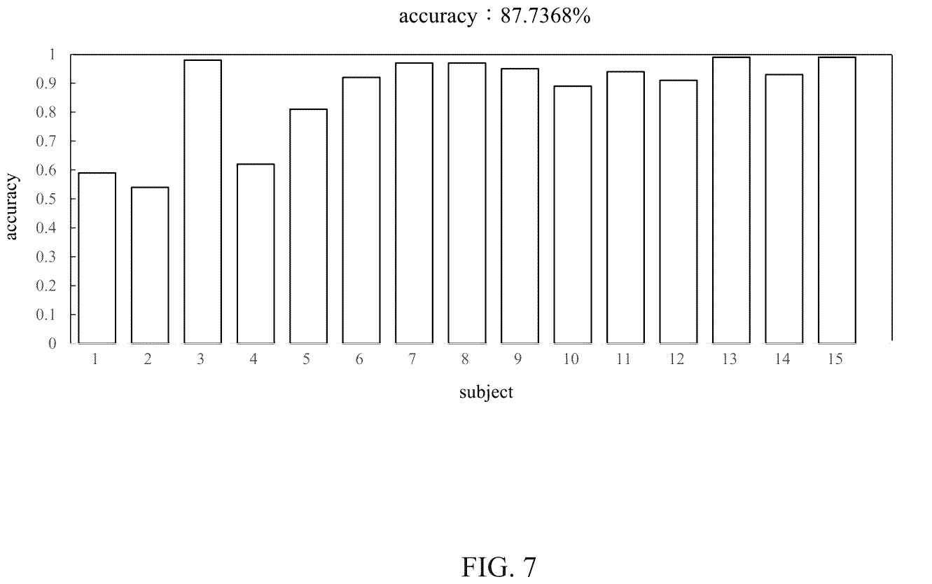

Firstly, the emotion recognition results on the SEED dataset are presented, and the HDC model is employed for binary classification (positive and negative), excluding the neutral emotion state. The hyperdimensional computing model with 10,000 dimensions is utilized and employed a leave-one-subject-out (LOSO) validation method. FIG. 7 illustrates the 2-class emotion classification results for 15 subjects on the SEED dataset. The average accuracy achieved is 87.74%. Notably, subjects 1, 2, 4, and 5 exhibit lower accuracy than the average, while most subjects achieve accuracy levels over 90% or near 100%.

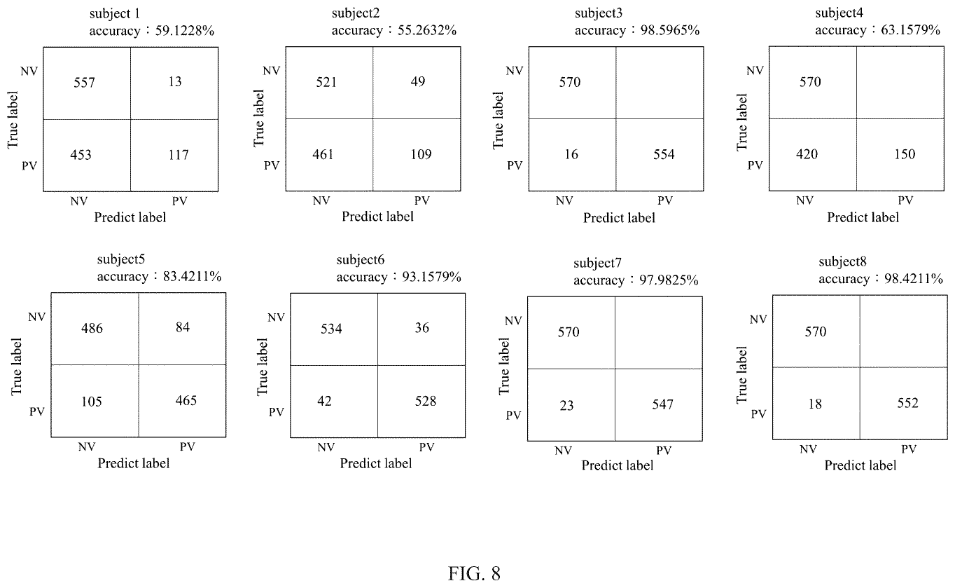

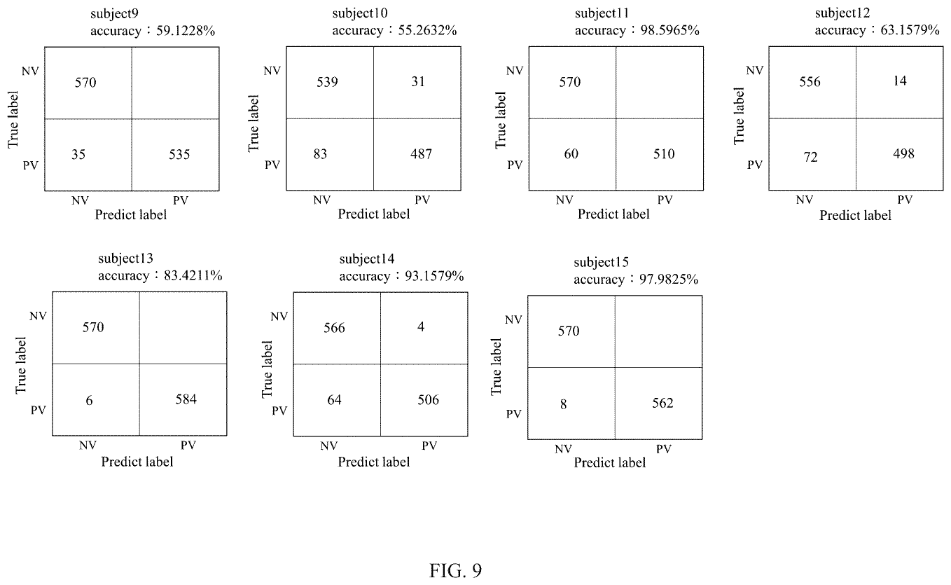

FIGS. 8 and 9 present the confusion matrices for individual subjects using the LOSOV method. It is observed that subjects with lower accuracy tend to misclassify the positive state as the negative state, while the negative state is classified correctly. This suggests that subjects 1, 2, 4, and 5 may exhibit more unusual patterns in their negative emotion states compared to other subjects. The majority vote method, employed for updating prototype, tends to store the main data patterns and dominates over the few unusual data patterns. Additionally, we analyze the Hamming distance of prototype, indicating how close the two different classes are. The average Hamming distance is 0.1409.

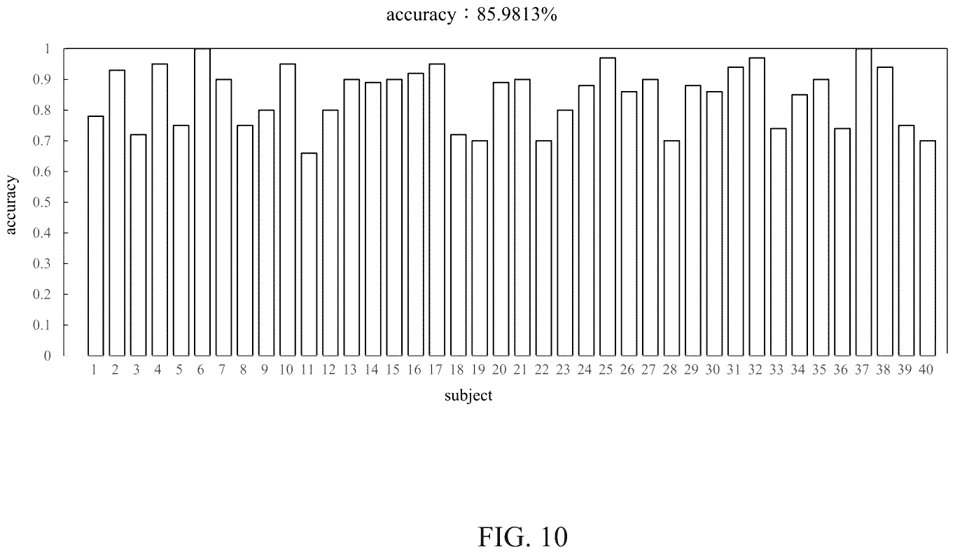

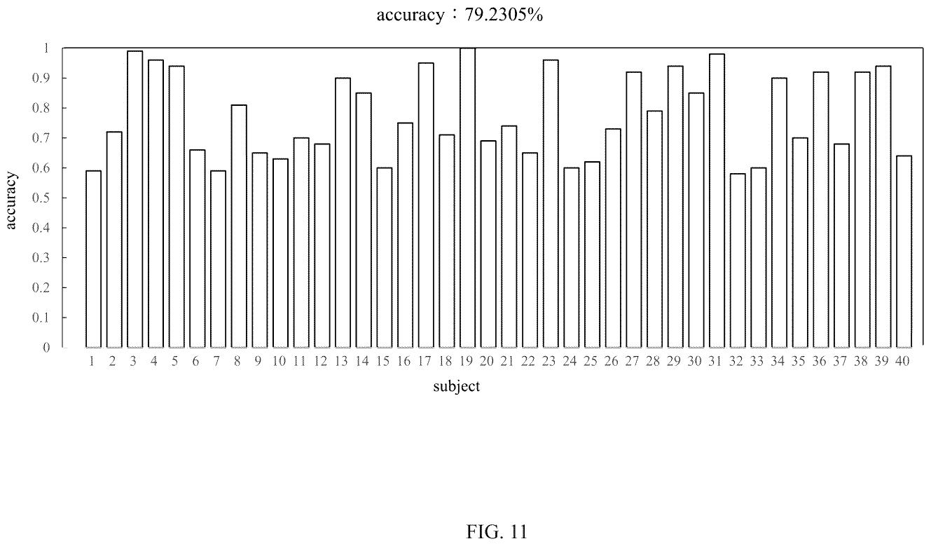

FIGS. 10 and 11 illustrate the 2-classification results of 40 subjects on the KMU dataset, including arousal and valence, with LOSO validation. The average accuracy is 85.98% for arousal and 79.23% for valence. The HDC model of the present invention performs better in classifying arousal compared to valence. The Hamming distance of arousal is about 0.086 which is higher than the Hamming distance of valence which is about 0.075. The difference of Hamming distance may cause the difference of average of accuracy between arousal and valence.

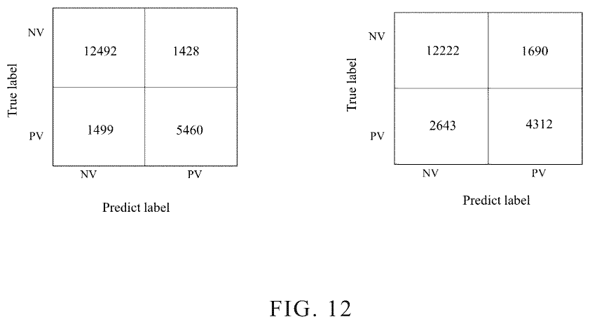

FIG. 12 displays the circumplex model of valence for 40 subjects on the KMU dataset, including arousal and valence. It is notable that there is an imbalance in validation samples. Unlike the SEED dataset, misclassified samples in the KMU dataset are equally distributed in the wrong class, whether arousal or valence.

In the emotion recognition system with a hyperdimensional computing accelerator, the present invention explores the emotion recognition systems within the field of affective computing, with a focus on EEG-based emotion recognition, relating to AI-driven healthcare. The hyperdimensional computing (HDC) model, with multiple sequential project memories, demonstrates comparable accuracy in emotion recognition.

In order to enable the objectives, technical features, and advantages of the invention to be more clearly understood by a person skilled in the art, the invention is further illustrated with the appended drawings, specifically to clarify the technical features and embodiments of the invention and provide better examples. The corresponding drawings below are not, and do not need to be, completely drawn according to the actual situation in order to express the meaning related to the features of the invention.

What is claimed is:

1. An emotion recognition system with a hyperdimensional computing accelerator, comprising:
a database including at least one original physiological signal;
a processor communicatively connected to the database, and the processor retrieving the at least one original physiological signal from the database and performing calculations; the processor comprising:
a feature extraction module processing the extracted original physiological signal to obtain a plurality of quantitative features; and
a hyperdimensional computing accelerator designed with a hardware circuit and communicatively connected to the processor through an interface, the quantitative features computed in the hyperdimensional computing accelerator to complete an initial training module and an emotion classification result; and
an electronic device communicatively connected to the processor through the interface, and used to display the initial training module and the emotional classification result;
wherein the hyperdimensional computing accelerator includes:
a top-level module managing all modules within the hyperdimensional computing accelerator and executing a finite state machine to process hyperdimensional computing in a pipeline fashion, selectively implement clock gating, which significantly reduces power consumption;
a mapping module encoding the quantized features, frequency information, and channel information through using hardwiring and cellular automata; and translating the quantized features into a binary hypervector of 10,000 dimensions and mapping frequency information and channel information into corresponding hypervectors;
a spatial module employing XNOR gates and a 9-bit accumulator for hypervector to implement binding and bundling operations to form a plurality of bound vectors, and are then bundling together to form a SE hypervector;
a temporal module utilizing a straightforward shift operation and a plurality of registers that store n-gram hypervectors to left-shift the SE hypervector by one bit, capturing sequential n-grams and amalgamate them into a TE hypervector; and
an associative memory module including an inference mode and a training mode; in the inference mode, a similarity check is applied to identify the closest relation between the temporal encoder (TE) hypervector and a prototype, thereby recognizing the corresponding classification; and in the training mode, a majority vote is implemented to bundle the TE hypervector with the prototype where the label is located within a window segment; and the prototype is then binarized into a binary hypervector to perform real-time emotion recognition, generating the emotion classification result and the initial training model.

2. The emotion recognition system according to claim 1, wherein the feature extraction module includes a high-pass filter, a short-time Fourier transformer, a band-pass filter, a baseline normalization operator, and a quantization operator; the high-pass filter eliminates baseline drift from the at least one raw physiological signal and minimizes noise to address potential disruptions caused by baseline drift; the short-time Fourier transformer converts the at least one physiological signal into a frequency domain spectrogram; the band-pass filter extracts the features from the alpha, beta, and gamma frequency bands; the baseline normalization operator scales each data point based on a mean value; and the quantization operator converts the features extracted by the band-pass filter into levels suitable for high-dimensional vector mapping.

3. The emotion recognition system according to claim 1, wherein the mapping module including an Item Memory mechanism and a continuous Item Memory mechanism, the Item Memory mechanism employs Rule 90 cellular automata to label a channel name, allowing the hypervector to be used for sequence extraction to generate a pseudorandom vector; in the continuous Item Memory mechanism, a d-dimensional pseudorandom vector acts as a first random seed, by intentionally flipping half of the bits (d/2) of the first random seed to generate the maximum level, the intentional flipping ensures that the hypervector representing the maximum level is dissimilar to the random seed representing the minimum level, as a Hamming distance is manually set to 0.5.

4. The emotion recognition system according to claim 1, wherein the associative memory module stores both an integer prototype and a binary prototype for two-class patterns, the binary prototype undergo updates in a 30-sample window every 5 times through thresholding of the integer window prototype in training mode.

5. The emotion recognition system according to claim 3, wherein during inference mode, a prototype stored in an associative memory register is extracted for comparison with the TE hypervector, and the Hamming distance computation involves XOR gates, addition trees, and comparators.

6. The emotion recognition system according to claim 3, wherein the Rule 90 cellular automata is a one-dimensional, binary cellular automaton rule, with each discrete time steps, each cell in a generation updates its state based on its own state and the states of its two neighbors from the previous generation, using a simple XOR operation.

7. The emotion recognition system according to claim 1, wherein in the spatial module, the binding and bundling operations functions to aggregate channel information, including the spectrogram, channel names, and frequency, after bundling operation, the resulting vector is binarized with a threshold set at half of its summation, threshold=(number of channels)×frequency/2.

8. The emotion recognition system according to claim 1, wherein in hyperdimensional computing, the permutation operation, denoted as ρ(A), can be applied recursively, projecting into previously unoccupied spaces with each iteration, the permutation operation effectively combines a hypervector with the position in a sequence, representing symbol at specific locations, the permutation operation creates dissimilar, pseudo-orthogonal hypervectors that maintain distances and are seamlessly distributed over bundling and binding operations.

9. The emotion recognition system according to claim 1, wherein channel number and a processing mode are configured, covering both inference and training modes, in ‘prototype in’ mode, pretrained prototype are loaded from a pre-trained model.

10. The emotion recognition system according to claim 9, wherein in the inference mode, the processor initializes prototype unless already stored in the associative memory, enabling direct processing if available, the input spectrogram then undergoes hyperdimensional computing, yielding an output.
